(19) United States
(12) Patent Application Publication
(10) Pub. No.: US 2025/0328592 A1
(43) Pub. Date: Oct. 23, 2025

(54) BACKGROUND CHECK SYSTEM

(71) Applicant: Charisma Check LLC, Tampa, FL (US)

(72) Inventors: Mohamad Hammam Alsafrjalani, Winter Park, FL (US); Obai Abdullah, Citrus Heights, CA (US); Muhammad Arafat, Tampa, FL (US); Loutfi Succari, Tampa, FL (US)

(73) Assignee: Charisma Check LLC, Tampa, FL (US)

(21) Appl. No.: 19/182,849

(22) Filed: Apr. 18, 2025

Related U.S. Application Data
(60) Provisional application No. 63/636,425, filed on Apr. 19, 2024.

(51) Int. Cl. G06F 16/9535; G06F 16/242; G06F 16/955; G06F 21/32

(52) U.S. Cl. CPC G06F 16/9535; G06F 16/2428; G06F 16/955; G06F 21/32

(57) ABSTRACT

A background check system allowing a user to generate a visual card from information from external background search providers and to share the card with other users. The system uses biometric verification to verify the subject user's identity, uses identification information provided by the user to request background information from the external providers, and processes the information to generate the card. The card does not include any of the subject user's sensitive personal information. The system can generate a public URL to access the subject user's card, which can be used to integrate access to the card into the subject user's profile in an external application, such as a dating site. The badge is displayed in the subject user's profile and can be activated by another user to display the card. The card can include a status indicator symbol indicating a safe or concern status based on the background information.

### CROSS REFERENCE TO RELATED APPLICATIONS

This application claims the domestic priority benefit of U.S. Provisional Application No. 63/636,425, filed Apr. 19, 2024 and entitled “BACKGROUND CHECK SYSTEM,” which is hereby incorporated by reference in its entirety.

### FIELD

The subject disclosure relates to the field of electronic background check systems, and more particularly to the generation and sharing of customized electronic background check reports.

### SUMMARY

According to an aspect of the disclosure, a background check system comprises a computing system, the computing system comprising a processor, a data storage, a user display, and user input hardware. The user input hardware is adapted and configured to allow a human user to enter user input into the computing system. The data storage includes a computer-readable application program. The processor is operatively connected to the data storage and adapted and configured to read and execute the application program from the data storage. The processor is operatively connected to the user display and adapted and configured to display a graphical user interface on the user display. The application program comprises instructions for the processor to: receive user input personal identification data of a subject user, the personal identification data including sensitive personal information of the subject user; receive input biometric data entered using the user input hardware; authenticate the input biometric data as being that of the subject user; transmit a background information request for the subject user to a background search provider database, the request including at least a portion of the user identification data; receive from the background search provider database background information about the subject user; generate from the background information and write to the data storage a background check card, the background check card comprising a digital image comprising a visual representation of at least a portion of the subject user's background information in a human-readable format, the sensitive personal information of the subject user being excluded from the background check card; display the background check card on the graphical user interface; display a share control on the graphical user interface; receive a user input activating the share control; when the share control is activated, generate share transmission content, the share transmission content comprising a copy of the background check card or a link to access the background check card from the data storage, and permit a user to transmit the share transmission content to a recipient electronic address.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein and, together with the description, explain the principles and operations of the claimed subject matter.

### BRIEF DESCRIPTION OF THE DRAWINGS

A complete understanding of the present embodiments and the advantages and features thereof will be more readily understood by reference to the following detailed description, appended claims, and accompanying drawings, wherein:

FIG. 1 is a block diagram of a computing system, in accordance with embodiments described herein;

FIG. 2 is a block diagram of an application program that is executable by the computing system of FIG. 1;

FIG. 3 is a block diagram of the application program in FIG. 2;

FIGS. 4A is a block diagram showing a deployment of a user server, an application server, and a user computing device in accordance with an embodiment described herein;

FIG. 4B is a block diagram showing a deployment of a user server and a user computing device in accordance with an embodiment described herein;

FIG. 4C is a block diagram showing a deployment of an enterprise engine server, an application server, and a user computing device in accordance with an embodiment described herein;

FIG. 5 is a flowchart of a process carried out by the application program, in accordance with embodiments described herein; and

FIG. 6 is a flowchart of a process carried out by the application program, in accordance with embodiments described herein.

FIG. 7 is an illustrative sequence of user interface display screen captures showing steps carried out using the application program on the user computing device of the deployments of FIGS. 4A-4C;

FIG. 8 is another illustrative sequence of user interface display screen captures showing steps carried out using the application program on the user computing device of the deployments of FIGS. 4A-4C;

FIG. 9 is another illustrative sequence of user interface display screen captures showing steps carried out using the application program on the user computing device of the deployments of FIGS. 4A-4C;

FIG. 10 is another illustrative sequence of user interface display screen captures showing steps carried out using the application program on the user computing device of the deployments of FIGS. 4A-4C;

FIG. 11 is another illustrative sequence of user interface display screen captures showing steps carried out using the application program on the user computing device of the deployments of FIGS. 4A-4C;

FIG. 12 is another illustrative sequence of user interface display screen captures showing steps carried out using the application program on the user computing device of the deployments of FIGS. 4A-4C;

FIG. 13 is an illustrative sequence of user interface display screen captures showing steps to integrate a feature of the application program into a third-party application program running on the user computing device of the deployments of FIGS. 4A-4C;

FIG. 14 is another illustrative sequence of user interface display screen captures showing steps to integrate a feature of the application program into a third-party application program running on the user computing device of the deployments of FIGS. 4A-4C.

### DETAILED DESCRIPTION

Reference will now be made in detail to the present preferred embodiment(s), and examples of which is/are illustrated in the accompanying drawings. Whenever possible, the same reference numerals will be used throughout the drawings to refer to the same or like parts. Any specific details of the embodiments are used for demonstration purposes only, and no unnecessary limitations or inferences are to be understood therefrom.

Before describing exemplary embodiments in detail, it is noted that the embodiments reside primarily in combinations of components and procedures related to a presently disclosed system and method. Accordingly, the system components and method procedures have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, apparatus, and/or computer program product at any possible technical detail level of integration. A computer program product can include, among other things, a computer-readable storage medium having computer-readable program instructions thereon for causing a processor to carry out aspects of the present disclosure. The computer-readable program instructions are said to be comprised in a computer-executable application program according to an aspect of the present disclosure.

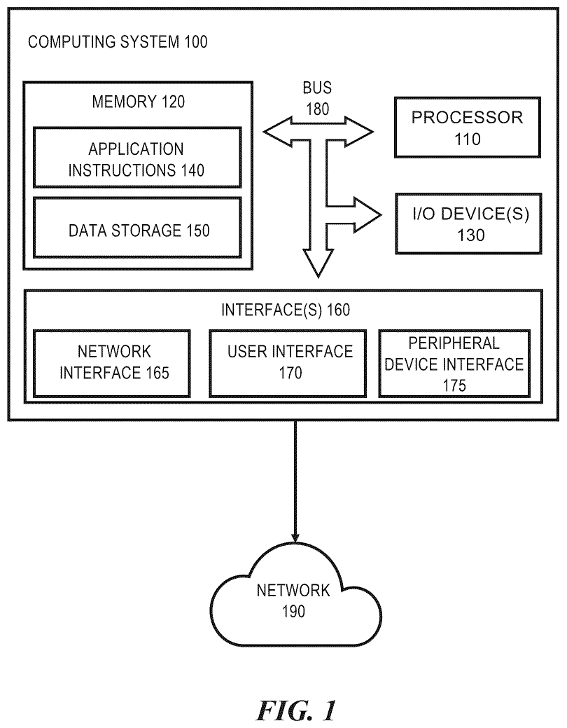

As shown in FIGS. 1-6, the various embodiments in this disclosure relate to computer implemented systems and methods for acquiring, processing, transmitting, and displaying personal background information about an end user of the application program (referred to herein as the “subject end user”). In particular, the acquired information is processed to generate and display a human-readable detailed background report on the subject end user, the background report containing some or all of the background information. In embodiments, the acquired information is processed to determine a background check “status” of the subject end user and to generate and display a visual status indicator. The status variable represented can, for example, be binary (such as whether or not the subject user's background report contains concerning items) or have some other low number of discrete values such as indicating no concern, a moderate level of concern, or a high level of concern. In some embodiments, the system requests access to one or more externally generated background reports for an end user; receives, indexes, and stores the data and information associated with the one or more background reports; processes the data and information associated with the one or more background reports; produces a processed background report and/or status indicator; displays the processed background report and/or status indicator; and transmits the background report and status indicator to a different end user or to another application program, such as that of a separate system or service platform. In some embodiments, one or more components and/or steps are omitted or repeated.

FIG. 1 illustrates an example of the system embodied as a computing system 100 that may be utilized to execute various procedures, including the processes described herein. The computing system 100 comprises a standalone computer or mobile computing device, a mainframe computer system, a workstation, a network computer, a desktop computer, a laptop, a virtualization, or the like. The computing system 100 can be embedded in a device, e.g., a mobile telephone, a personal digital assistant (PDA), a mobile audio or video player, a game console, a Global Positioning System (GPS) receiver, a cloud computing platform, or a portable storage device (e.g., a universal serial bus (USB) flash drive).

In some embodiments, the computing system 100 includes one or more processor(s) 110 coupled to a memory 120 through a system bus 180 that couples various system components, such as an input/output (I/O) device 130, to the processor 110. The processor 100 may be any suitable architecture (ISA), including, for example, Intel x86,Intel x64, ARM, Advance Micro Devices (AMD). The memory 120 may be any suitable type, including, for example, static random-access memory (SRAM), flash memory, dynamic random access memory (DRAM). The application instructions 140 and data storage 150 may exist on one or multiple types of memory in the computing system 100. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computing system 100 includes one or more input/output (I/O) devices 130, such as video device(s) (e.g., a camera), audio device(s), and display(s) are in operable communication with the computing system 100. In some embodiments, similar I/O devices 130 may be separate from the computing system 100 and may interact with one or more nodes of the computing system 100 through a wired or wireless connection, such as over a network interface.

Processor 110 is suitable for the execution of computer readable program instructions include both general and special purpose microprocessors and any one or more processors of any digital computing device. For example, each processor 110 may be a single processing unit or a plurality of processing units, and may include a single or multiple computing units or multiple processing cores. The processor(s) 110 can be implemented as one or more microprocessors, microcomputers, microcontrollers, digital signal processors, central processing units, state machines, logic circuitries, application specific integrated circuit (ASIC), and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 140, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C #, JAVA, JAVASCRIPT, PERL, Swift, Flutter, Angular, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (NVRAM) (e.g., ferroelectric RAM (FeRAM)). Volatile memory can include, for example, RAM, dynamic RAM (DRAM), etc., which can act as external memory or on-chip cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. In some embodiments, the application instructions 140 can execute entirely on the user's computer, partly on the user's computer, as a stand-alone software package, partly on the user's computer and partly on a remote computer, or entirely on the remote computer or server (e.g., a data center accessible via a cloud computing platform). In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In this disclosure, the term “user” refers to the end user unless otherwise specified. In some embodiments, the system can re-evaluate and re-analyze the status of a user and depict the status change to the user.

In some embodiments, the application instructions 140 can be downloaded to a computing/processing device from a computer readable storage medium, or to an external computer or external storage device via a network 190. In some embodiments, the application instructions 140 can be relayed to the computing/processing device via an operating system distribution store, such as the Android App on Google Play or Apple App Store. A network adapter card or network interface in each computing/processing device receives computer readable program instructions from the network and forwards the computer readable application instructions 140 for storage in a computer readable storage medium within the respective computing/processing device.

In some embodiments, the computing system 100 includes one or more interfaces 160 that allow the computing system 100 to interact with other systems, devices, or computing environments. In some embodiments, the computing system 100 comprises a network interface 165 to communicate with a network 190. In some embodiments, the network interface 165 is configured to allow data to be exchanged between the computing system 100 and other devices attached to the network 190, such as other computer systems, or between nodes of the computing system 100. In various embodiments, the network interface 165 may support communication via wired or wireless general data networks, such as any suitable type of Ethernet network, for example, via telecommunications/telephony networks such as an analog voice interface or a digital fiber communications interface, via storage area interfaces such as Fiber Channel SANs, via a local wireless interface (e.g., Bluetooth or Wi-Fi dongles), near field communication (NFC), or via any other suitable type of network, protocol, and/or interface. Other interfaces include the user interface 170 and the peripheral device interface 175.

User interfaces 170 allow the computing system 100 to relay and/or take-in information to and/or from an end user. User interfaces 170 can be any hardware or software components configured to allow the user to enter input information into the computing system 100 or receive output information from the computing system 100. A display (which may be touchscreen and thus both an input and output user interface), mouse, keyboard, software-emulated keyboard, speakers, headphones, and earbuds are examples of user interfaces.

Peripheral device interface 175 allows the computing system 100 to interact with devices that are local to the computing systems or remote on other computing systems. Universal serial bus (USB), and serial advanced technology attachment (SATA) are examples of peripheral device interfaces.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computing system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

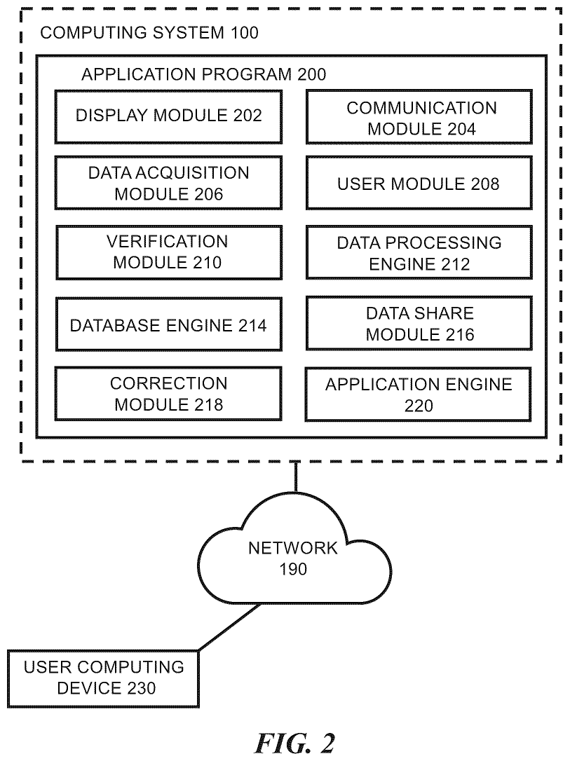

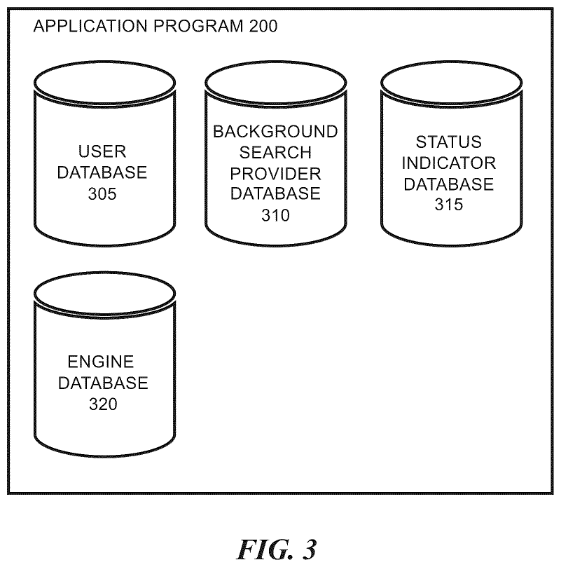

FIG. 2 and FIG. 3 illustrate an example computer architecture for the application program 200 described herein. FIG. 2 is a block diagram showing the module and engine components needed to perform the various specific tasks within the computing system 100. In some embodiments, the computing system 100 is hosted on a cloud computing device at a remote data center that is managed by a cloud service provider. In particular, FIG. 2 shows the components of the application program 200, which comprises a plurality of modules and engines configured to implement the processes and subprocesses of the background check system described herein. FIG. 3 is a block diagram showing the one or more databases utilized by the various modules and engines in FIG. 2.

FIG. 2 illustrates a block diagram of an application program 200, which provides the components utilized to implement systems and methods described herein. In some embodiments, the application program 200 comprises one or more of a display module 202, communication module 204, data acquisition module 206, end-user module 208, verification module 210, data processing engine 212, database engine 214, data share module 216, correction module 218, and application engine 220, each of which is configured to work and communicate with one another. As shown in FIG. 2, the application program 200 is in communication with, via the network 190, one or more cloud computing devices and one or more user computing device(s), including the user computing device 230.

In some embodiments, the display module 202 contains the logic necessary to display one or more graphic user interfaces. In some embodiments, the display module 202 is configured to temporarily generate and display various pieces of information in response to one or more commands or operations. The various pieces of information or data generated and displayed may be transiently generated and displayed, and the displayed content in the display module 202 may be refreshed and replaced with different content upon the receipt of different commands or operations. In some embodiments, the various pieces of information generated and displayed via the display module 202 may not be persistently stored. In some embodiments, the display module 202 is configured to generate a background report or status indicator of an end user of the application program 200.

In some embodiments, the status indicator is defined to indicate a result of the background check(s) and subsequent processing thereof, such as whether the subject user has events in their background of a type that may be considered a safety concern for the recipient of the report. For example, events of a certain type may be classified by category and/or by an associated concern level. A set of two or more concern levels (such as concern/no concern, or high concern/moderate concern/no concern) can be defined universally for all users of the system. Events can be classified by a number of characteristics, which can include, by way of non-limiting examples: whether the event is civil or criminal; whether it is a civil case filing, judgment, citation, arrest, charge/indictment, or conviction; a type of incident or offense, such as a civil dispute, traffic citation, or criminal matter; whether any alleged criminal act constitutes a non-violent, violent, or sexual offense, and in turn whether such offense is classified as a misdemeanor or felony. More particularly, in embodiments, the application program 200 can comprise instructions pre-defining types, classes, and characteristics as properties of events. The data processing engine 212 can be adapted and configured to automatically identify and index background data into discrete events and to determine the values of such properties for each event. In embodiments, events are automatically so parsed and indexed from raw data by default, while optionally seeking verification and/or accepting corrective and/or clarifying inputs from the subject user.

In some embodiments, the status indicator for the background information is represented by an icon displayed in the user interface. In other embodiments, the status indicator may comprise or consist of text indicating a concern level, a type of event (or lack thereof) in the background information giving rise to the concern level, and/or a text summary of specific information extracted from a more detailed background report. In some embodiments, the background information is displayed in a format that includes the status indicator and/or such a more detailed background report.

In some embodiments, the visualization of the background report generated by the disclosed systems and methods further comprises an insignia (not shown in the drawings) of one or more external information providers, contact information, charts, documents, and/or data that has been integrated into the displayed report. The display of such an insignia can signify that the external information provider has reviewed and certifies the accuracy and/or authenticity of some or all of the contents of the visualization. Alternatively, the insignia can be incorporated within an exact copy of a graphic image obtained directly from the external information provider and displayed without alteration and can serve to certify the source of only that graphic image. In embodiments or cases in which the insignia represents review and certification of the background report visualization as a whole by the external information provider, the display module 202 can be prevented from displaying the insignia with any subsequently altered visualization unless and until the external information provider has reviewed and certified such altered visualization. The altered visualization may for example include a user's correction of an item of information obtained from the provider, a user's deletion/removal or marking as false/inaccurate an item of information obtained by from the provider and/or marking as true/accurate a conflicting item of information from another provider, and/or any supplemental information volunteered by the user, such as to clarify or present context for an item in the background report. In embodiments, the data acquisition module 206 is adapted and configured to resubmit the altered visualization to the external provider for such re-certification whenever such alterations are made, optionally specifying/enumerating each change that was made to call the attention of the external provider to the changes (such as for review and authentication by an individual authorized by the external provider to re-certify the background report, or for processing and automated certification by a computer system of the external provider), and to receive certification from the external provider authorizing the presently disclosed system to (re-)apply the external provider's insignia to the altered visualization. In embodiments, the subject user can choose whether to share the altered visualization immediately without the external provider's insignia and to have the insignia reincorporated as an update upon receipt of the external provider's authorization, or to delay sharing the altered visualization until such time as the external provider has re-certified the visualization in its altered form.

In some embodiments, the communication module 204 contains the logic necessary to allow an end user to communicate with another end user, an admin-user, and/or a third-party person or system (e.g., a device, an account associated with another application program, or an email or other electronic address, associated with the person or system). In such embodiments, the communications can include an email or direct message originating from within the application program 200, an email or direct message that is facilitated by a secondary software service (e.g., add-on or plug-in), or a telephone communication that is facilitated by a third-party service provider that is accessible from the application program 200.

In some embodiments, the communication module 204 is configured to synchronize the data and information stored in the application program 200 between or across one or more users, one or more devices (e.g., user device, cloud computing device), and/or one or more databases (e.g., cloud database). In some embodiments, the communications module 204 is configured to associate communication identifiers (e.g., unique user IDs) with a particular user and/or user device.

In some embodiments, the communication module 204 is configured to provide (e.g., push) notifications to a user. For example, when the data and information in a background report of an end user is changed or updated, the communication module 204 can transmit notifications and/or communications to a user's device to provide a real-time, or near real-time, updates to the background report(s) for the end user.

In some embodiments, the data acquisition module 206 contains the logic necessary to call on external systems (such as those of third-party providers) and to acquire data and information regarding one or more users. In some embodiments, the data and information is associated with a user's background report (e.g., criminal history), litigation history, credit report, professional licensing, or educational accomplishments for the one or more users. In some embodiments, the data and information are limited to one or more predetermined periods (e.g., day, week, month, year). In some embodiments, the data acquisition module 206 is configured to repeat periodically its call on external systems and acquisition of data and information (such as any new or updated information) regarding one or more end users.

In some embodiments, the user module 208 contains the logic necessary to acquire and store personal information from a user (e.g., an end user). In some embodiments, the user module 208 comprises an onboarding process for creating an account. In such embodiments, the user defines a username and password and selects communication preferences (input email address and/or mobile device phone number). In some embodiments, the user module 208 is configured to request access to the device identification information (e.g., serial number) so the mobile device can be registered to the end user's account. In some embodiments, the user module 208 implements a questionnaire for the user to complete. For example, the onboarding process can require the completion of the questionnaire. The questionnaire can be configured to solicit personal information including, for example, legal name, social security number, date of birth, citizenship, current residence address, previous residence address, criminal history and outcomes, financial history and outcomes, litigation history, etc. The username established by a user during the onboarding process will be used by the user module 208 as an ID for that user, for example, for other users to be able to locate or contact that user. During use, the application program 200 will prompt users to complete the questionnaire. The data and information received from the users will be stored in a database. In some embodiments, the application program 200 will occasionally require the users to confirm the accuracy of or provide an update to the data and information stored in the database.

In some embodiments, the data share module 216 contains the logic necessary to enable users to request, approve/grant, accept, or decline the sharing of background information (e.g., report or status indicator) with other users. The data-share module 216 communicates with the display module 202 to display the information to the user. In some embodiments, the data share module 216 allows users to share their background information without revealing the user's sensitive data (e.g., social security number, date of birth, address, full legal name). In some embodiments, the data-share module 216 communicates with the user module 208 to access, search, and retrieve the contact information for another user. For example, the user module 208 provides access to the user database 305 and allows one user to search for another user by, e.g., their username. After the user finds the other user, the data share module 216 contains instructions that prompt the user to request a report or share a report with the other user. In some embodiments, the data-share module 216 communicates with the communication module 208 to process the request and, if appropriate, to transmit the requested action.

In some embodiments, the verification module 210 contains the logic necessary to confirm whether a user is who they claim to be. Because sensitive personal information may be included in the data and information obtained from third party vendors as well as from the users, the application program 200 will prevent undesired access to a user's background report. In some embodiments, in which a user wants to display a user background report via a mobile application, the program must verify that the user account is registered to the user who is the subject of the background report and/or otherwise authorized to access the report. In some embodiments, the user must upload an official form of identification (e.g., driver's license, passport) that will be associated with the account. Subsequent to creating the user account, the user will need to allow the system to access the camera of the user's device so the verification module 210 can confirm the facial features match the face shown on the government ID for that account. Furthermore, in some embodiments, in which a user wants to transmit her own user background report to another user, the verification module 210 can require confirmation of the user account of the subject user in order to permit the transmission. In some embodiments, the confirmation of the subject user's account includes requiring the subject user to confirm certain personal information (e.g., address, past address, former name, etc.) that is stored in a user database before allowing the subject user to access her account and/or to transmit a report.

In some embodiments, the data processing engine 212 is configured to aggregate the data sets obtained by the data acquisition module 206 from the external (e.g., third-party) source(s). In some embodiments, the data processing engine 212 is configured to compare and contrast the information provided by the end user and the third-party vendors, obtained from the end-user module 208 and data acquisition module 206, respectively, and to identify inconsistencies between the sources of information. In some embodiments, the data processing engine 212 contains the logic necessary to convert the accumulated and reconciled raw data and information for the user into a customized report and/or a status indicator (as later defined and described in detail).

In some embodiments, the database engine 214 is configured to facilitate the storage, management, and retrieval of data to and from one or more storage mediums, such as the one or more databases 305, 310, 315, and 320 shown in FIG. 3. In some embodiments, the database engine 214 is configured as an in-process get, set, and update mechanism coupled to various sources, including, for example, volatile, in-process, or shared memory (e.g., RAM; application state). In some embodiments, the database engine 214 is configured with get, set, and update functions to call for an application programming interface (API) (e.g., a HTTP request) to interact with databases and data stored on external web servers (e.g., cloud or private servers). In some embodiments, the database engine 214 is configured with get, set, and update functions to interact with data stored on attached non-volatile storage including, for example, a hard drive. In some embodiments, the database engine 214 is coupled to an external storage system including, for example, a USB-connected storage device. In some embodiments, the database engine 214 is configured to apply changes to one or more databases. In some embodiments, the database engine 214 comprises a search engine component for searching through thousands of data sources stored in different locations.

In some embodiments, the correction module 218 comprises the logic necessary for a user to request assistance to have one or more items in a background check corrected for want of accuracy or other reasons (e.g., expunged information). The application program 200 allows a user to review her background report. In situations in which certain information is incorrect, the user can request correction of the information prior to sharing the report with another user. In some embodiments, the correction module 218 communicates with the communication module 208 to process the request for assistance, and the communication module 208 directs the user to help (e.g., another user or third-party).

In some embodiments, the application engine 220 is configured to deploy the application program 200 to and from one or more servers. In some embodiments, one or more of the respective servers is in the cloud. In some embodiments, one or more of the respective servers is a private server.

As shown in FIG. 3, a plurality of databases is included in the application program 200. In some embodiments, the application program 200 and the plurality of databases in the computing system 100 are hosted on a cloud computing device. In some embodiments, each database is in communication with the various components in the application program 200 via the database engine 214, and with one or more user computing devices 230 via the network 190. In some embodiments, for example, the application program 200 comprises a combination or a subcombination of the following databases: a user database 305, a background search provider database 310, a status indicator database 315, and an engine database 320.

In some embodiments, the user database 305 stores the data and information associated with each user of the system, including their name, e-mail address, unique user ID, device(s) information, questionnaire answers, personal information (social security number, date of birth, address history), account credentials (e.g., username, telephone number, password, biometric data), session-derived data, and/or any other information relevant to the usage of the application program 200. In some embodiments, the user database 305 stores the data related to user-sessions, including, for example, transmitting a background report and/or status indicator to another user. In some embodiments, the user database 305 stores the data related to user personalization and preferences (e.g., system-inferred settings). In some embodiments, user settings and preferences, including system-defined or system-inferred customizations, may be utilized by one or more modules of the application program 200.

In some embodiments, the third-party background search provider database 310 retrievably stores the information and data related to the third-party background search providers used for the application program 200. In some embodiments, the third- party background search provider database 310 stores the raw data from the third-party search reports that will be converted into a customized background report for a particular user. In some embodiments, the database 310 stores and indexes data and information required for API connections, licensing agreements, and other data associated with communications to and from the third-party background search providers.

In some embodiments, the status indicator database 315 retrievably stores the information and data related to one or more status indicators that will be created, indexed, stored, analyzed, and displayed by the application program 200. The status indicators are based on the raw data and information provided by the one or more third-party background search reports.

In some embodiments, the engine database 320 retrievably stores information and data related to the deployment of the application program 200. In some embodiments, the output commands and logic stored in the engine database 320 are utilized throughout the computing system 100.

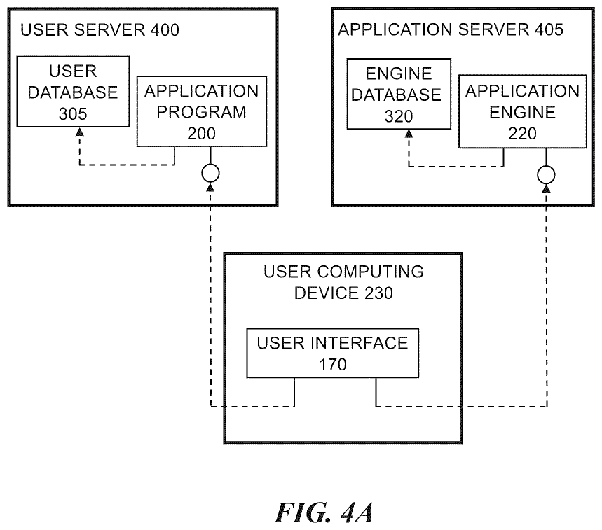

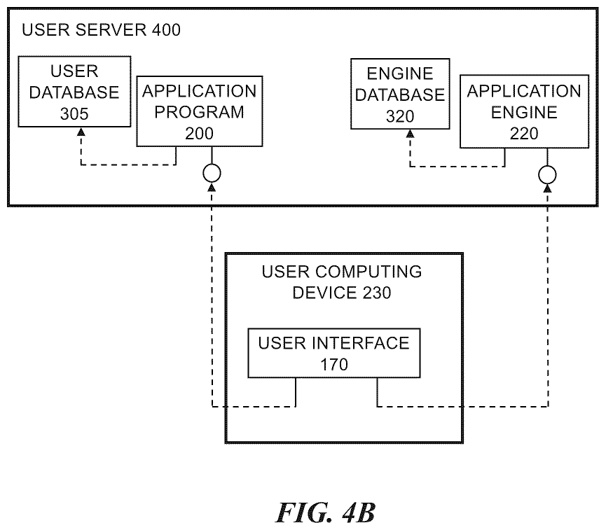

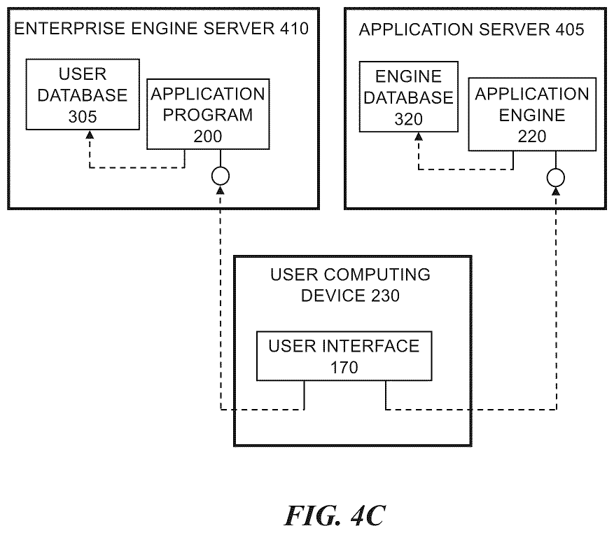

FIGS. 4A, 4B, and 4C illustrate embodiments for the deployment of servers involved with the application program 200. In some embodiments, as shown in FIG. 4A, the user data is stored on the user's server space 400, and the application engine 218 is hosted on the application server space 405. Both the user server space 400 and the application server space 405 can be in the cloud or on private servers. In some embodiments, as shown in FIG. 4B, the user's server space 400 holds both the application program 200 and the application engine 218. In some embodiments, as shown in FIG. 4C, the user accesses the application program 200 hosted on the enterprise engine server space 410, and the application engine 220 is hosted on the application server space 405.

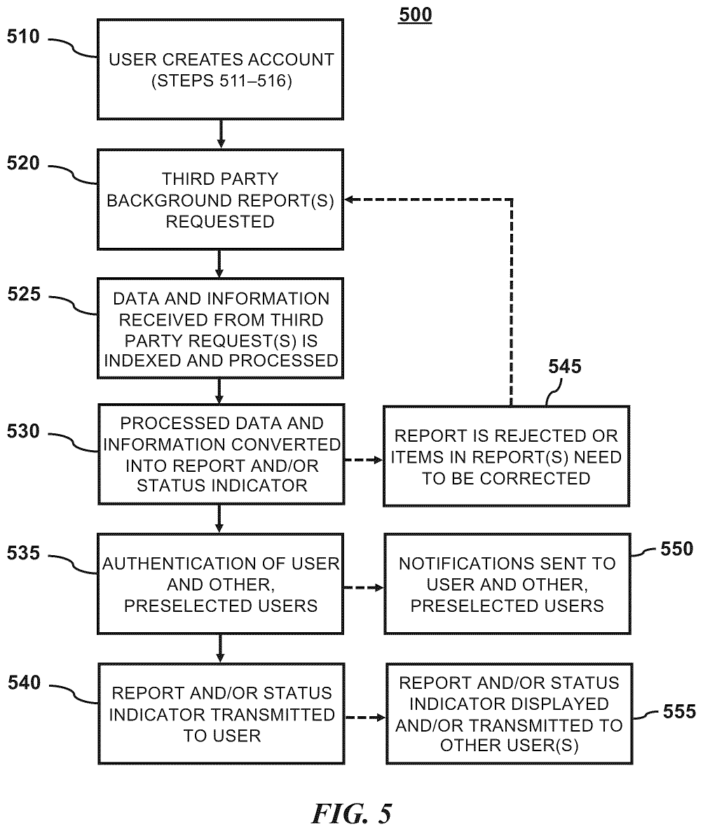

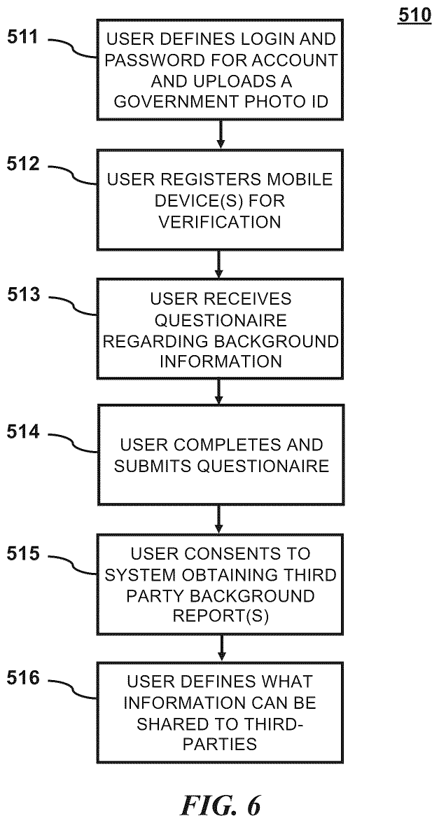

FIG. 5 illustrates a computer-implemented process, or software, 500 for an exemplary embodiment of this disclosure. In some embodiments, the process 500 comprises a plurality of steps, including a user creating an account 510; requesting one or more third-party background reports 520; receiving, indexing, and processing the data and information provided by the third-party background report(s) 525; converting the processed data and information into a customized report and/or status indicator 530; authenticating the users and associated devices 535; displaying and/or transmitting the customized report and/or status indicator 540; optionally notifying the users of a report and/or status indicator change 550; and, optionally challenging an item in the report provided by the external provider(s) 545 (e.g., third-party background check vendor(s)). As shown in FIG. 6, the step of the user creating an account 510 can include a plurality of substeps 511-516.

In some embodiments, the process 500 comprises the step 510 with a user creating an account. In addition to creating a login and password for the account in step 511, which will be stored in a database for the user, the user is directed to upload a copy of her government-issued photo identification (e.g., driver's license, passport). In some embodiments, the process 500 further registers one or more mobile devices with the account in step 512. In some embodiments, the step 513 includes the application program 200 transmitting a questionnaire to the user. The questionnaire will require the user to provide personal information (e.g., address, social security number, address history), and that data and information will be used for verification purposes or when processing the data and information received from third-party background reports obtained in the process 500. Any such transmittals to or from the user are indexed in a ledger saved in the database for the user. Step 514 involves, after completion of the questionnaire, the transmittal of the completed questionnaire from the user to the database where it can be subsequently retrieved for processing. Step 515 requires the user to define or set parameters for the scope of consent. Consent is required for the application program 200 to retrieve third-party background reports and, in step 516, to transmit processed reports and/or status indicators to the user and to other users in the system. The responses and settings obtained from the user are saved in the database for the user.

In some embodiments, the process 500 comprises the step 520 of submitting a request to an external provider (typically a third-party) for one or more background reports for the user. The background reports can be obtained from private vendors or from government agencies. The reports can include criminal history, litigation history, financial and credit information, educational accomplishments (e.g., validation of degree(s) alleged to have been earned), etc. Any requests for third-party reports are stored in a database for the user.

In some embodiments, the process 500 comprises the step 525 of receiving the one or more background reports for the user. The data and information obtained from different third parties may be presented in different formats and may be inconsistent between the reports. The application program 200 treats the data and information received from third-party sources as raw data. Any reports received from the third-party sources are saved in a database for the user. In some embodiments, the process 500 comprises the step 525 further includes indexing and processing the raw data and information obtained from third-party sources. The data can be indexed based on selected parameters (e.g., year) or categories (criminal charges and results (e.g., convicted, dismissed), civil litigation history, educational history, achievements, etc.). The data and information are processed and analyzed with the information provided by the end user for inconsistencies.

In some embodiments, the process 500 comprises the step 530 of converting the processed data and information from step 525 into a customized report and/or status indicator. The customized report can be based on the aggregation of information from one or more third-party background reports after removal of duplicate entries, incorrect information, etc., and presented in a user-friendly format for display on a mobile device or desktop computer. In some embodiments, the processed data and information from step 525 is converted into a status indicator. In this context, the status indicator can be one or more symbols, text, or a combination of the one or more symbols and text. In some embodiments, a series of status indicators are provided. For example, the status indicator can be a symbol (e.g., check mark) that is defined to mean there were no items from any source that require further consideration or would objectively raise a concern for another user in the system. For example, the status indicator can be a symbol (e.g., “X”) that is defined to mean that there were certain items from one or more sources that may be of concern, and to suggest further investigation and consideration by the recipient. For example, the status indicator can be a symbol (e.g., “\textcircled{\}” (circle-backslash or interdictory symbol)) that is defined to mean there were certain items from one or more sources that would be objectively concerning for other users (e.g., conviction for a violent crime). There can be any number of predefined status indicators, which through use of the application program 200 would be learned and recognized by the end users of the system. In some embodiments, the display module 202 contains the logic for displaying the status indicator on a device for easy recognition.

In some embodiments, as shown in FIG. 5, the process 500 comprises the optional step 545 of rejecting one or more third-party background check reports and/or challenging one or more items included in the one or more third-party background check reports. In such embodiments, the method 500 provides a process for the user to identify incorrect information in a report and have it corrected. The step 545 can involve contacting another user or a third-party identified in the report to have the information updated. Any steps taken for correcting an item listed in a third-party report are stored in a database for the end user.

In some embodiments, the process 500 comprises the step 535 of authenticating the user and the device employing the application program 200. In some embodiments, the authenticating step 535 includes two or more sub steps, including: identification (the device sends an identification request to the authentication server. This request includes some form of unique identifier such as a MAC address or serial number); authentication (the authentication server checks the identification request against a list of authorized devices or credentials. This is typically done by verifying a digital signature or certificate provided by the device.); and authorization (if the device is successfully authenticated, the authentication server grants access to the requested resources or actions. This can be done by assigning the device a token or session ID that allows it to access the authorized resources.). One or more techniques of authentication can be used, including password-based authentication (the device sends a username and password to the authentication server, which checks it against a database of authorized users.), a certificate-based authentication (the device presents a digital certificate that contains its public key and a digital signature that is verified by the authentication server.), two-factor authentication (the device presents two forms of identification, such as a password and a one-time code sent to a mobile phone, to authenticate itself.), and biometric authentication (the device uses biometric data, such as fingerprint or facial recognition, to authenticate itself.).

In some embodiments, the process 500 comprises the step 540 of transmitting the customized report to a user device. The customized report is stored in a database for the user and, when completed, can be requested and/or pushed to the user device where, after receipt, it can be displayed and viewed by the user. In some embodiments, the step 540 of transmitting further comprises, or in the alternative comprises, the transmission of a status indicator, which can be displayed and viewed by the user on the user device. In some embodiments, the step 540 comprises an option for a user to request the report of another user. In such embodiments, the application program 200 comprises a search feature that allows a user to search the user database 305 for the username of another user. If the username is located, the user can request a report from that user and commence a request process. If the username is not located, the user cannot request a report from that user. In some embodiments, the subject user will receive the request from the other user and will be prompted with instructions for responding. In such embodiments, instructions will request an approval or denial to the request.

In some embodiments, the process 500 comprises the optional step 550 of sending a notification to the user to indicate a new report and/or status indicator is available. In some embodiments, the application program 200 pushes a notification to a user device prior to transmitting the report and/or status indicator. In some embodiments, the application program 200 simultaneously pushes a notification to a user device and transmits the report and/or status indicator.

In some embodiments, the process 500 comprises the optional step 555 of sending a notification to another user (i.e., other than the subject user) to indicate a new report and/or status indicator is available for the subject user. In some embodiments, the application program 200 pushes a notification to a user device prior to transmitting the report and/or status indicator. In some embodiments, the application program 200 simultaneously pushes a notification to a user device and transmits the report and/or status indicator.

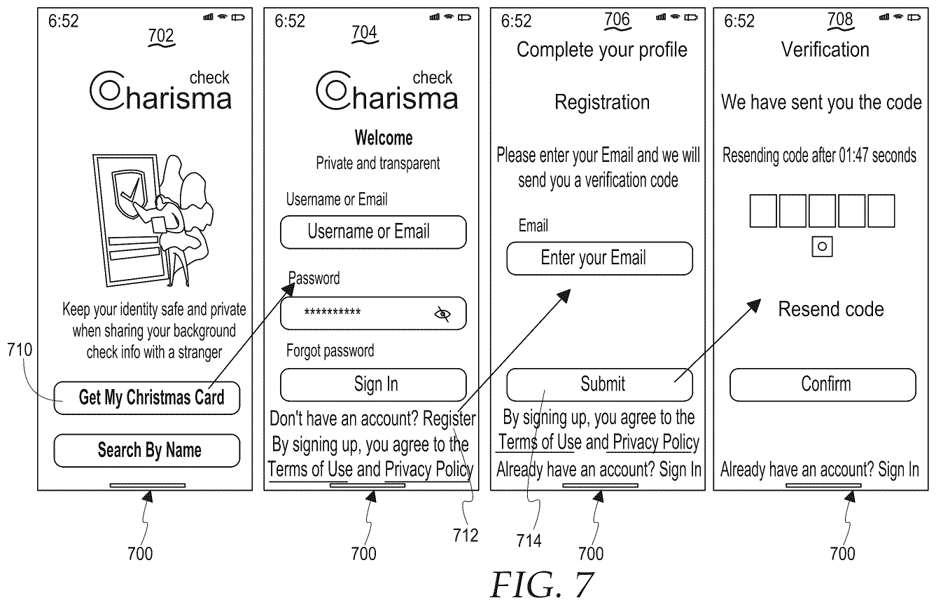

FIGS. 7-14 depict exemplary flow-through sequences of screen captures or user-interface views (“UI views”) on a graphical user interface 700 displayed on a display by the computing system 100 running the application program 200, in accordance with an embodiment. The graphical user interface 700 is illustrated in a form that may be displayed on a typical mobile communication device display, and in particular a touchscreen of a smartphone device, but in embodiments of the disclosure, a display can be that of a computer monitor, laptop computer, television set, tablet device, or other electronic display device.

Turning to FIG. 7, a flow-through sequence of UI views 702, 704, 706, 708 illustrate initial steps to register an account in the application program 200. In particular, a user activates a Get My Charisma Card button 710 on an initial screen 702 to open a Welcome/Sign-in screen 704, in which the user then activates a Register hyperlink 712 to open a Registration screen 706. The user then enters their email address on the Registration screen 706 and activates a Submit button 714. In response, the computing system 100 displays a Verification screen 708, transmits a verification code to the email address entered by the user, and waits for the user to retrieve and enter the verification code on the Verification screen 708 prior to the expiration of a displayed countdown timer.

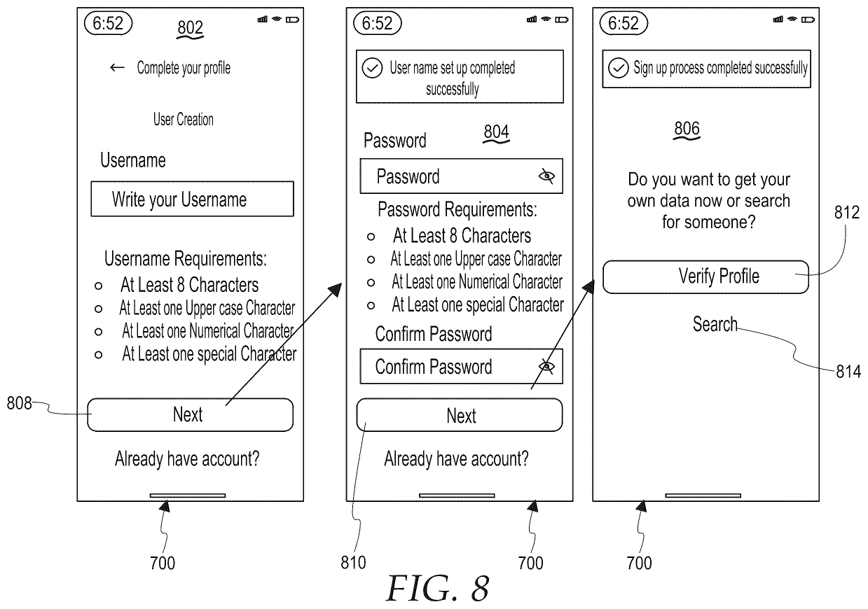

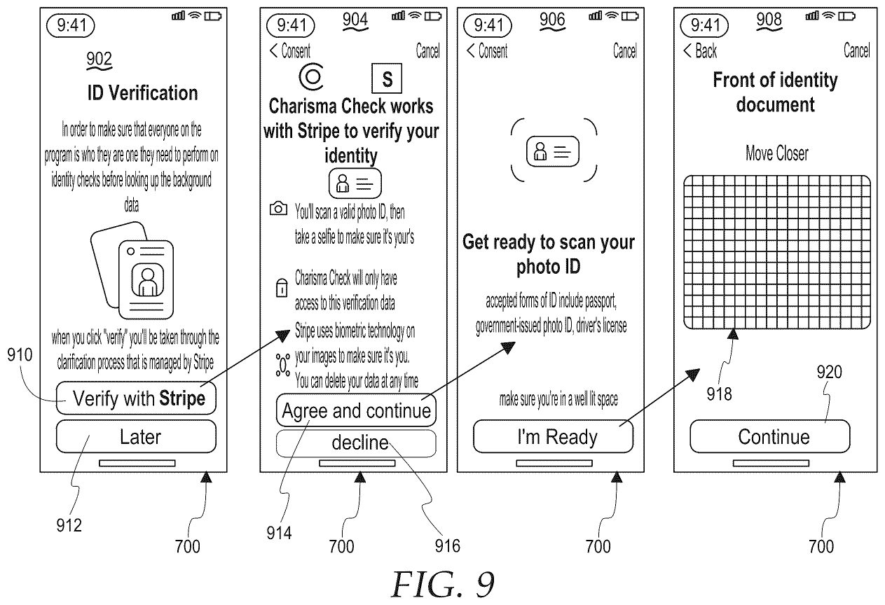

FIG. 8 illustrates username and password creation and initial action selection following email verification as shown in FIG. 7, in three views 802-806. In particular, a user selects and enters a username on a User creation screen 802 and activates a Next button 808 to open a Password creation screen 804, and then selects and enters a password on the Password creation screen 804 and activates a Next button 810 to open an initial action selection screen 806, which prompts a user to select whether to generate the user's own background report or to search for another user's background report, by displaying a Verify Profile button 812 and a Search hyperlink 814. When a user activates the Verify Profile button 812, the application program 200 initiates an ID verification sequence as shown in FIGS. 9-11. When a user activates the Search hyperlink 814, a search interface (not shown) will be displayed to permit the user to enter a text search query for another user, such as that user's username in the application program 200, to view a profile of that user, which may include at least a background check report card 1116 of that user, to be described below.

FIG. 9 shows views 902-908 of an ID verification sequence. On an initial ID Verification screen 902, a user can activate either a Verify button 910 or a Later button 912. User activation of the Verify button 910 causes a Consent screen 904 to be displayed. In an embodiment, when a user activates the Later button 912, the initial action selection screen 806 is again displayed until a user either activates the Verify Profile button 812 again or the Search hyperlink 814. On the Consent screen 904, a disclosure is presented to the user, for example informing the user that an external application (such as that of a third party) will be used to employ biometric technology on images captured by the user using a camera I/O device 130 of the computing system 100. A user can agree or decline consent to such usage of the user's images by activating an Agree and Continue button 914 or a Decline button 916. When the user activates the Agree and Continue button 914, a get ready to scan screen 906 is displayed, prompting the user to prepare to scan an accepted form of photo identification. When a user activates an I′m Ready button 916 on the get ready screen 906, a front side capture screen 908 is opened, wherein a viewfinder frame 918 is displayed, and the processor 130 is directed to display a live video stream of image frames being captured by a camera I/O device 130 of the computing system 100 in the viewfinder frame 918. A user is prompted on the front side capture screen 908 to move a front side of the user's photo ID document into suitable proximity and alignment with the camera I/O device 130, and when suitable position is detected, a Continue button 920 is enabled, and an image frame containing an image of the photo ID document is stored to the user database 305 in the data storage 150, either automatically upon the processor detecting a suitable image of the photo ID document, or when the user activates the enabled Continue button 920.

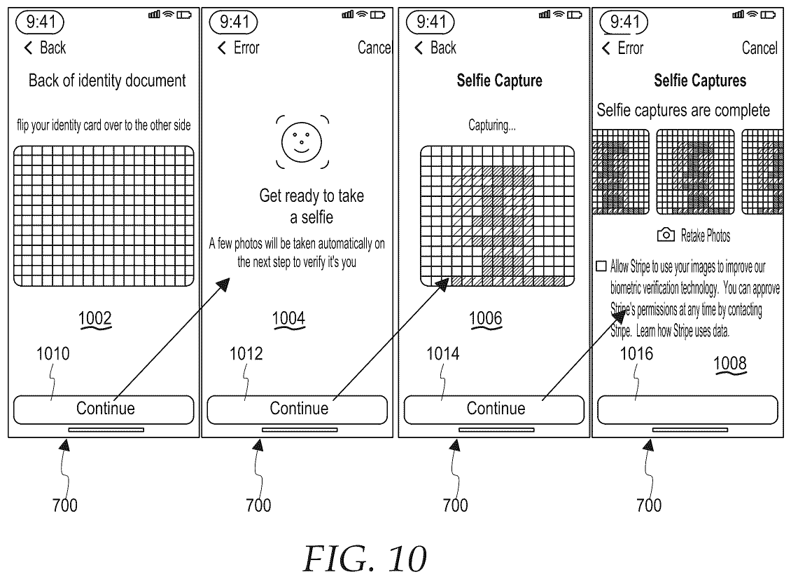

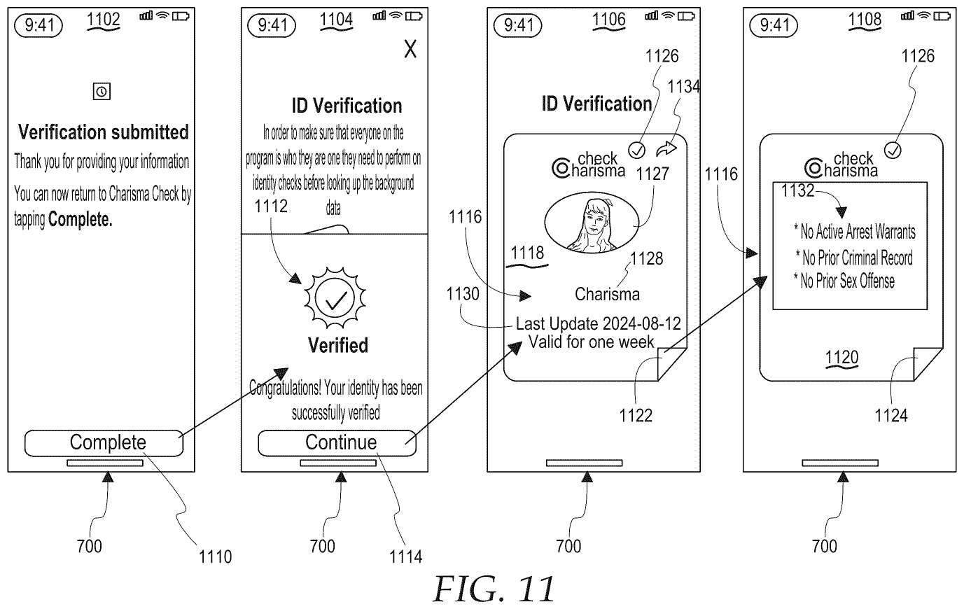

Turning to FIG. 10, a continuation of the ID verification sequence is illustrated in views 1002-1008. In a back-side capture screen 1002, a live video stream from the camera I/O is again presented in the graphical user interface 700 within the viewfinder frame 918, and the user is similarly prompted to present the back side of the user's photo ID document to the camera I/O device 130 for similar capture and storage of a back-side photo image. When a Continue button 1010 is enabled and activated by the user, a get ready for selfie screen 1004 is displayed prompting a user to get ready to capture a selfie photo. When ready, the user activates another Continue button 1012 to open a Selfie Captures screen 1006, wherein the user is similarly prompted to position the user's face relative to a camera I/O device 130 (in this step, typically a front-facing camera device in the case of a smartphone or tablet camera device, to enable the user to see the user's own face in the digital viewfinder frame 918). When the processor detects that the user's face is properly positioned one or more times to capture one or more selfies, one or more image frames of the user's face captured by the camera I/O device 130 are then stored to the user database 305 in the data storage 150, and another Continue button 1014 is enabled, which the user can then activate to open a Selfie Captures confirmation screen 1008 comprising a message to the user that selfie captures are complete. Optionally, the confirmation screen 1008 can further prompt the user to select whether to grant permission to the application program 200 and/or to an external application (such as that referred to on the Consent screen 904. Regardless of the user's selection, when the user activates another Continue button 1016 on the confirmation screen 1008, the first screen 1102 of FIG. 11 is opened.

Turning to FIG. 11, views 1102-1108 are shown, which illustrate the conclusion of the verification process and the appearance of a background check report card produced by the execution of the application program 200 according to an embodiment of the disclosed method. The first view is a Verification Submitted screen 1102 which indicates that the user has provided the required information and can return to a home dashboard of the application program 200 by activating a Complete button 1110. When the user activates the Complete button 1110, an ID Verification screen 1104 is displayed, which informs the user that an identity check is being performed before retrieving the user's background data, and the application program 200 initiates a biometric comparison of the user's selfie photo image(s) with the user's photo ID document image, which in the illustrated embodiment is performed by the external application mentioned above, which then returns the result of the comparison to be processed by the application program 200. Upon receiving input confirming that the biometric comparison is a match, the application program displays a Verified message 1112 on the ID Verification screen 1104. A user can then activate a Continue button 1114, in response to which the application program 200 proceeds to perform a background check for the user by making calls to external system databases and aggregating and processing data as previously described.

When the background check is completed, the application program 200 generates a virtual background check report card 1116 having a “front” side 1118 as shown on the screen 1106 and a “back” side 1120 as shown on the screen 1108. In embodiments, a visual indicator of the two-sidedness of the card 1116 is displayed on each of its sides 1118, 1120, such as the respective front-side and back-side dog-eared corners 1122, 1124 shown on the screen captures 1106, 1108, respectively. The visual indicators 1122, 1124 can also function as active controls that allow the user to toggle between sides of the card 1116 by tapping and/or by swiping (such as in a direction from the dog-eared corner to the opposite corner) the respective front/back visual indicator 1122, 1124 to show the reverse back/front side 1120, 1118 of the card. As illustrated, the front side 1118 of the card 1116 shows background check status information including a cleared (i.e., positive, safe) status indicator symbol 1126 shown as a check mark, an ID verified photo image 1127 that was captured as a selfie during the previously described verification process, a name 1128, and a date of last update 1130. According to an embodiment, the application program 200 automatically updates the background check report card 1116 on a periodic basis, such as monthly, for a given user by repeating the background data-gathering and processing steps of the method according this disclosure. In another embodiment, the application program 200 updates a user's background check upon a request submitted through the user interface by the subject user. In still another embodiment, the application program 200 can allow one user to transmit an update request to another user, which can optionally be anonymous, thus prompting the other user to choose whether to respond by updating their background check as requested, and optionally to choose whether to inform the requesting user of the response via the application program 200. Such on-demand background check updating can be provided in lieu of or in addition to automatic periodic updating. In embodiments, the frequency of automatic updates by the application program 200 can depend on a paid subscription status of a particular user. In still other embodiments, a user can purchase on-demand updates of their own background check on the application program 200 on a one-time basis.

In turn, the back side 1120 of the card 1116 shows background check detailed information 1132 and the status indicator symbol 1126. In addition, the front side 1118 also includes a share link 1134, which when activated by the user enables the user to share their card 1116, for example, with another user of the application program 200 or to an external application program, such as that of a third-party platform, for viewing by other users of that platform, or with anyone having access to an internet browser application. Advantageously, this facilitates a trustless person-to-person background verification exchange in which another person is able to verify the user's background to their satisfaction without the user having to share with the other person the user's full name or other such sensitive information about the user as would otherwise be required for the other person to be able to perform their own background check on the user.

In some cases, the data acquisition module 206 may be unable to confirm or determine one or more basic or important items of information about a subject user, for example, the user's date of birth. Reports for which such items of information could not be confirmed or determined (whether or not the item itself is designated sensitive and therefore excluded from the background check report card 1116) may be designated “low confidence,” such as by text or other indicia (not shown) applied to the front and/or back side 1118, 1120 of the card 1116.

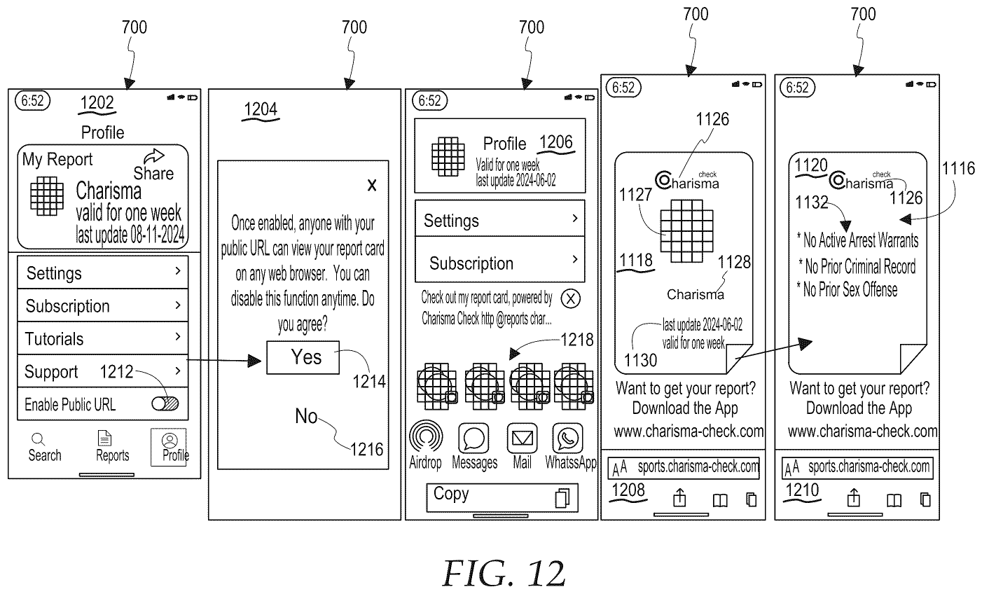

Turning to FIG. 12, views 1202-1210 illustrate a method of sharing a user's background check report card 1116 using a public URL sharing feature of the application program 200. A profile home screen 1202 is shown to include an Enable Public URL toggle control 1212, which, when toggled to an enabled state by a user, allows anyone with a public URL associated with the user to access and view the user's background check report card 1116 in any web browser. For example, when the user has enabled the toggle control 1212, the application program 200 directs the enterprise engine server 410 to grant all HTTP GET requests to view the user's background check report card 1116 as stored in the user database 305, and when the user has disabled the toggle control 1212, the application program 200 directs the enterprise server 410 to deny all such HTTP GET requests. When a user enables toggle control 1212, a confirmation prompt pops up as in the screen 1204, which informs a user of the effect of enabling the user's public URL and asks the user to indicate agreement by a Yes or No selection 1214, 1216. A Yes selection 1214 confirms enablement of the user's public URL, whereas a No selection 1216 cancels it. The sharing process according to an embodiment is illustrated in views 1206-1210. With the toggle control 1212 enabled, a user activating the share link 1134 can result in displaying a share menu such as the sharing panel 1218 as shown on the screen 1206, which permits a user either to directly select an external application through which to share the user's public URL or to select “Copy” to copy the link and a sharing message to be pasted into any field, which will be readily recognized as similar to commonly employed sharing tools integrated into the user interfaces of various existing mobile device applications and/or operating systems. In turn, the screen captures 1208, 1210 illustrate the front and back sides 1118, 1120 of a user's background check report card 1116 as accessed by a web browser from the user's enabled public URL address.

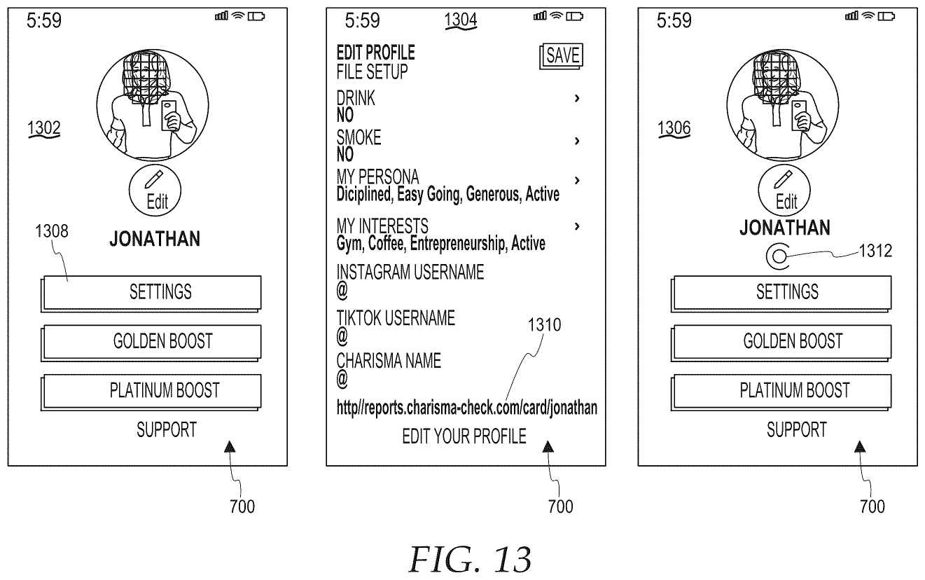

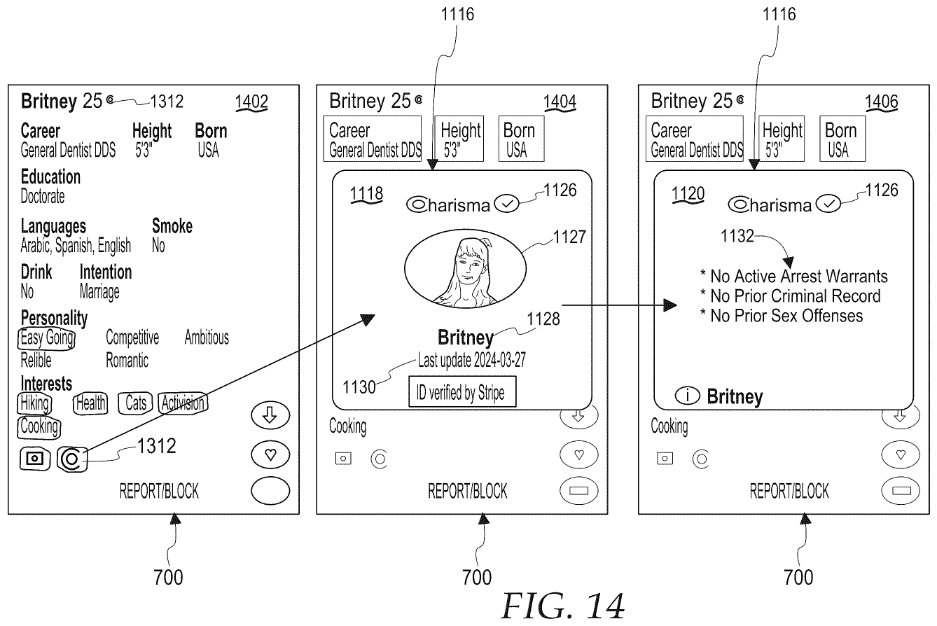

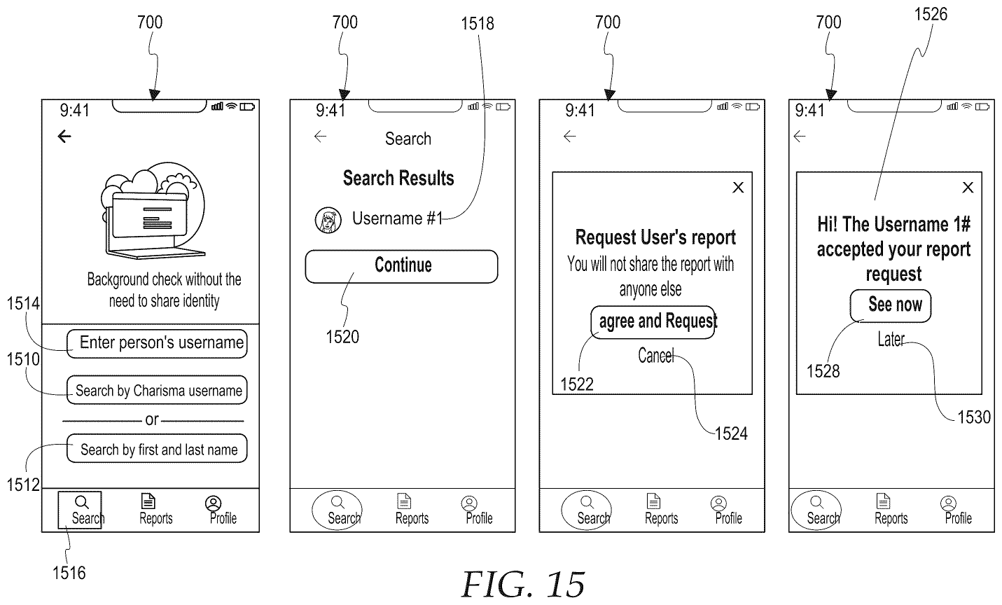

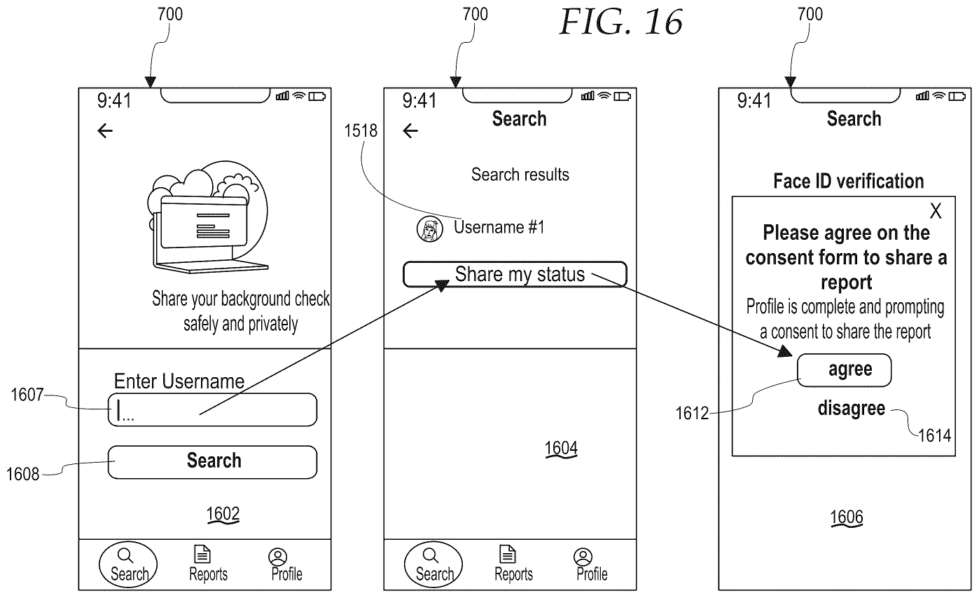

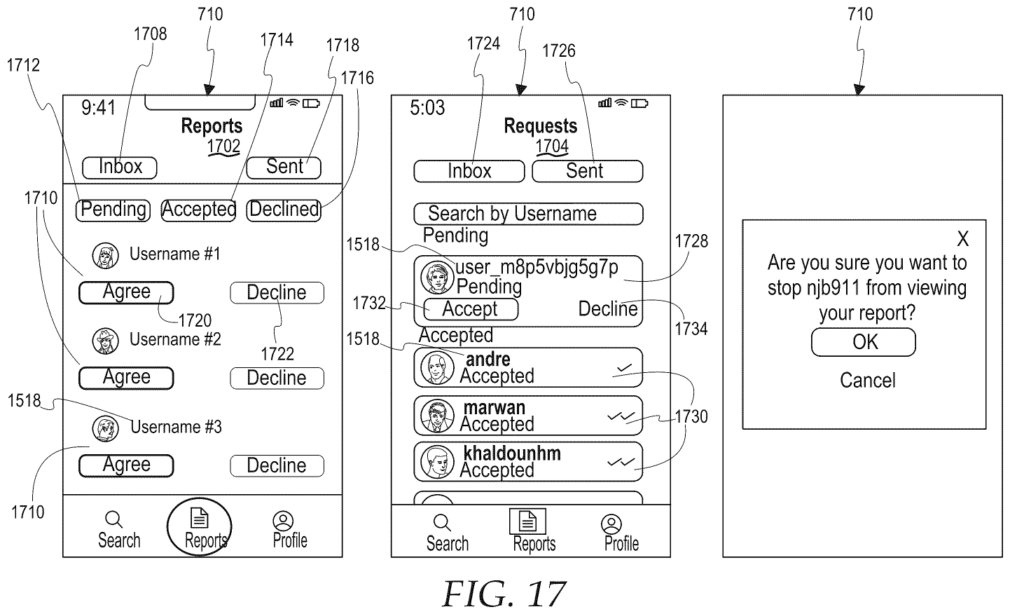

FIGS. 13 and 14 illustrate how access to a user's background check report card 1116 can be integrated into a user's profile in an external application 1300, by way of non-limiting example. More particularly, the external application 1300 is illustrated as a hypothetical mobile dating app 1300, on which users can view the profiles of other users, indicate interest in another user, and when interest is reciprocated by the other user, communicate with that user via the app 1300.

Turning to FIG. 13, the views 1302-1306 show a flow-through of a user Jonathan incorporating his background check report card 1116 into his profile on the app 1300. First Jonathan selects a settings option 1308 on his user account screen 1302 to open a settings menu screen 1304, and he enters the public URL associated with his background check report card 1116 on the application program 200 into an associated settings field 1310. Then, background check badge 1312 appears below his name on his updated account home screen 1306.

Turning to FIG. 14, there is illustrated how the background check report card and badge features of the application program 200 are integrated into a user profile as viewed by other users of the app 1300, in views 1402-1406. Thus, in a profile details screen 1402 for user Britney, together with personal details about Britney presented in various fields, there is displayed Britney's background check badge 1312, in one location at the top of the screen next to her username, as well as in another location near the bottom of the screen on a button 1408. A user pressing the button 1408 activates a link to display the front side 1118 of Britney's background check report card 1116, as shown on the next screen 1404. In this illustration, the visual “flip” indicators 1122, 1124 are omitted from the front and back sides 1118, 1120 of Britney's card 1116. In this case, according to one embodiment, a user can toggle or flip between the front and back sides 1118, 1120 by simply tapping within the area of each.

In embodiments, an update request button or link (not shown) can be displayed on one or both sides of Britney's card 1116 for an authenticated user of the app 1300 to transmit a request to Britney to update her background check, via one or both applications 200, 1300. Such a request can optionally be transmitted anonymously, as described above for such a request from one user of the app 200 to another. Still more particularly, Britney may receive the request only through the app 200, so that the request can be anonymous not only as to the identity of the user making the request but also as to the app through which the user made the request. In other embodiments, Britney may receive the request through the app 200 but be informed of the application or platform on which the request originated. In embodiments of a third-party method of integrating features of the application program 200 into the app 1300, the app 1300 may allow one of its users to request an update of another user's card 1116 only after such other user has indicated interest in the requesting user, so that its users do not become inundated with unsolicited background check update requests. In still other embodiments, a requesting user must share their identity with the subject user in order to transmit a background check update request to the subject user, unless the subject user has first indicated interest in the requesting user, so that the subject user may choose whether to review or to mute or ignore any such non-anonymous request.

As previously mentioned and described, in embodiments of a report-transmission step 540, background check reports can be requested and shared by users within the graphical user interface 700 of the application program 200. Screen-capture sequences in accordance with one such embodiment are illustrated in FIGS. 15-17. With reference to FIG. 15, views 1502-1508 of the user interface 700 illustrate a sequence in which a user of the application program 200 requests a subject user's report and is notified that the subject user has accepted (granted) the request. In a user search view 1502, a user can select whether to search for a subject user by username or legal name, by activating a corresponding selection control 1510 or 1512. As illustrated, the user has activated the search-by-username selection control 1510 (or left a default search-by-username mode activated by making no selection), entered a name to search in the field 1514, and then activated a search control 1516 to initiate a search. In response to the user's input, the application program 200 displays the search results view 1504 showing one user. In a preferred embodiment, each user of the application program 200 has a unique username 1518, such that the displayed search results will either identify one user, as shown in the view 1504, or indicate that no user was found (not shown). In the illustrated case in which a user having the username 1518 is found, the searching user can proceed to a request view 1506 by activating a continue control 1520. In the request view 1506, the user is prompted whether to request the subject user's report, which requires the user to indicating agreement not to share the report, or to cancel the request, by activating a corresponding selection control 1522, 1524. As illustrated, the user activates the agree and request control 1522, in response to which the request is submitted to the subject user. Subsequently, if the subject user accepts the request, the requesting user can be contemporaneously notified in a pop-up message 1526 appearing in the notification view 1508. The requesting user can then enter either a See Now selection 1528, in response to which the subject user's report card 1116 will be displayed immediately, or a Later selection 1530 to close the pop-up message 1526 and restore a previous view.

Turning to FIG. 16, there is shown an illustrative sequence of views 1602-1606 in which a subject user can share their own report with a target recipient user identified by that user's username 1518. The subject user first enters a username in a search field 1607 shown in a search view 1602 and activates a search control 1608. In response, a search results view 1604 is displayed, in this case showing a user having the username 1518. Within the search results view 1604, the subject user can activate a share control 1610 to bring up a share prompt view 1606. In the share prompt view 1606, the subject user can make an Agree selection 1612, in response to which the application program 200 will transmit the subject user's report to the target recipient user having the username 1518, or a Disagree (or cancel) selection 1614, in response to which the application program 200 will display another view, such as the search view 1602, on the user interface 700 without transmitting the subject user's report.

Turning to FIG. 17, there are shown illustrative mailbox views 1702-1706 displayed in the user interface 700. A user can interact with a Reports mailbox 1702 to manage incoming and outgoing report sharing transmissions. In particular, a Reports Inbox tab 1708 can be toggled to manage incoming report sharing transmissions 1710, which typically will consist of unsolicited transmissions, as requests for reports from other subject users are managed in the Requests mailbox 1704. Within the Reports Inbox tab 1708, a user can select whether to display Pending 1712, Accepted 1714, or Declined 1716 transmissions; as illustrated, the transmissions 1710 are Pending 1712. (The statuses of outgoing share transmissions can be similarly monitored by toggling a Sent Reports tab 1718, though not shown in FIG. 17.) Each incoming share transmission 1710 is displayed with the corresponding username 1518 corresponding Agree and Decline controls 1720, 1722, which can be activated to agree or decline to receive the subject user's report. Activating the agree control 1720 can display a prompt analogous to that of view 1508 in which the user can select to see the received report now or later.

The Requests mailbox 1704 similarly includes a Requests Inbox tab 1724 and a Sent Requests tab 1726. As shown, the Requests Inbox tab 1724 is toggled, to display incoming requests from other users, identified by requesting username 1518 and grouped according to whether the requests are Pending 1728 or Accepted 1730. Each pending request 1728 is displayed with Accept/Decline controls 1732, 1734 which can be activated to accept (grant) or decline (deny) the incoming request to view the user's report, respectively. For Accepted requests 1730, one checkmark is displayed if the subject user's report has been delivered to the requesting user, and two checkmarks are displayed if the requesting user has viewed the subject user's report. Selecting an Accepted request 1730 can give the user an option to revoke (not shown) access that was previously granted to the associated requesting user 1518, which a user can confirm or cancel in the view 1706. (Analogously, selecting an outgoing share transmission-not shown-that has been accepted from within the Sent Reports tab 1718 can give the user the option to revoke unsolicited report access that the user previously shared with a recipient user, which can likewise be confirmed or canceled in a view analogous to the view 1706.)

In another embodiment (not shown), the application program 200 can permit a subject user and a recipient user to enter respective “bump” modes in which the subject user's report can be transmitted to the recipient user by “bumping” or bringing the respective devices into close proximity or contact with each other, such as via Bluetooth® or other suitable short-range wireless data transmission protocol. A indication that the “bump” mode is activated will be displayed to the user, and such display will be considered an embodiment of a displayed share control, while “bumping” a pair of devices in their respective “bump” mode will be considered an embodiment of activating such a displayed share control, in accordance with this disclosure.

In various embodiments, the system, program, and methods described herein for acquiring, processing, transmitting, and displaying personal background information as a report or status indicator for an end user of the application program provides advantages over existing systems or programs. Existing systems for background reports enable or allow an end user to look up their own background information and enable or allow the end user to file a background check application to a third-party provider. But end users are not able to share or use the reports obtained from such systems with other users or with other third-parties because there are several challenges. Third parties generally will not accept a report obtained by the user because such a chain of custody may allow the user to manipulate information in the report. As such, third-party reports may inherently involve a lack of trust, credibility, and/or authenticity. Existing systems allow users to look up their own report or status or look up the status and/or report for other individuals, but those systems do not provide a two-way consent between the individuals and do not include a method for post-report validation.

Furthermore, existing systems for background reports do not allow the subject user to securely transmit or initiate secure transmission of the user's own authenticated report. Existing systems for background reports do not allow the subject user to control, via consent settings, which information (e.g., sensitive personal information) is transmitted to other users. Existing systems for background reports do not allow the subject user to display a status indicator to other users or other people external to the system who want to quickly ascertain a general level of trustworthiness and/or credibility of the subject user. Existing systems for background report do not allow automatic and/or periodic updates.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the flowchart and block diagrams in the figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the logic and functions of two or more modules can be combined into a single module. In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular data types. Those skilled in the art would appreciate the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A background check system comprising
a computing system, the computing system comprising a processor, a data storage, a user display, and user input hardware;
the user input hardware being adapted and configured to allow a human user to enter user input into the computing system;
the data storage including a computer-readable application program;
the processor being operatively connected to the data storage and adapted and configured to read and execute the application program from the data storage;
the processor being operatively connected to the user display and adapted and configured to display a graphical user interface on the user display;
the application program comprising instructions for the processor to:
receive user input personal identification data of a subject user, the personal identification data including sensitive personal information of the subject user;
receive input biometric data entered using the user input hardware;
authenticate the input biometric data as being that of the subject user;
transmit a background information request for the subject user to a background search provider database, the request including at least a portion of the personal identification data;
receive from the background search provider database background information about the subject user;
generate from the background information and write to the data storage a background check card, the background check card comprising a digital image comprising a visual representation of at least a portion of the subject user's background information in a human-readable format, the sensitive personal information of the subject user being excluded from the background check card;
display the background check card on the graphical user interface;
display a share control on the graphical user interface;
receive a user input activating the share control;
when the share control is activated, generate share transmission content, the share transmission content comprising a copy of the background check card or a link to access the background check card from the data storage, and permit a user to transmit the share transmission content to a recipient electronic address.

2. The background check system of claim 1 wherein the application program further comprises instructions for the processor to determine whether the background information received from the background search provider database includes a specific type of information, and when the background information excludes the specific type of information, to include in the background check card a visual indicator of low confidence.

3. The background check system of claim 2 wherein the type of information is a date of birth.

4. The background check system of claim 1 wherein the application program further comprises instructions for the processor to display a link toggle switch, the link toggle switch having an enabled state and a disabled state and being operative, when in the enabled state, to allow the background check card to be accessed from the data storage using said link, and when in the disabled state, to deny access to the background check card from the data storage using said link.

5. The background check system of claim 1 wherein said link comprises a uniform resource locator (URL) address of the background check status card in the data storage.

6. The background check system of claim 1 wherein the background check card comprises a status indicator symbol, the status indicator symbol indicating the presence or absence of a concern based on the subject user's background information.

7. The background check system of claim 6 wherein the status indicator symbol can further indicate a suggestion to review the subject user's background information details for a potential concern.

8. The background check system of claim 1 wherein the background check card comprises a front side image and a back side image, the front side image including a username of the subject user, a biometric image of the subject user, a date on which the background check card was generated, the back side image including details of the subject user's background information, and at least one of the front side image and the back side image includes the status indicator symbol.

9. The background check system of claim 8 wherein the biometric image is a photograph of the subject user.

10. The background check system of claim 8 wherein each of the front side image and the back side image further includes a flip control, the flip control being operative, when activated by a user, to display the other side image on the graphical user interface.

11. The background check system of claim 10 wherein the flip control is represented as a folded corner of an area of the background check card, wherein the display and the user input hardware comprise a touchscreen, and wherein the flip control is operative to be activated by a user swiping in a direction from the folded corner into the area of the background check card.

12. The background check system of claim 1 wherein the application program further comprises instructions for the processor to update the subject user's background check card at a periodic time interval by repeating the operations of transmitting said request to the background search provider database, receiving said background information, and generating the background check card.

13. The background check system of claim 12 wherein the periodic time interval is one month.

14. The background check system of claim 12, the application program further comprising instructions for the processor to, when the subject user's background check card is updated, send a notification to the recipient electronic address to indicate an updated background check card is available for the subject user.

15. The background check system of claim 1 wherein the application program instructions for the processor to transmit said background information request and to receive said background information comprises instructions to transmit the request and receive the background information to and from a plurality of different background search providers, and said generating the background check card from the background information comprises processing the background information, said processing including indexing information items, removing duplicate information items, identifying inconsistent information items, and removing incorrect information items.

16. The background check system of claim 15, wherein said identifying inconsistent information items and removing incorrect information items include presenting on the graphical user interface a notification of the inconsistent information items and a prompt to select whether to keep, remove, or correct each item, receiving input selections from the user, and keeping, removing, or correcting each item in accordance with the user input selections.

17. The background check system of claim 1 wherein the application program further comprises a search engine module, the search engine module comprising instructions for the processor to search a plurality of external databases for background information about the subject user and to transmit said background information request to, and receive said background information from, such databases as are found to contain background information about the subject user.

18. A method of integrating the background check system according to claim 1 into an external application program, wherein the background check card share transmission content comprises said link, the external application program comprising a plurality of user profiles associated with a corresponding plurality of user accounts, whereby a user logged into one of the user accounts on a user device can, within a graphical user interface of the external application program, create and edit the user's user profile, view other users' user profiles on a display of the user device, invite other users to connect by interacting with their profiles, and accept or decline connection invitations from other users, the method comprising:
the subject user activating the share control of the background check system to generate said background check card link;
the subject user copying said link from the background check system application program;
the subject user logging into a user account on the external application program on a user device of the subject user;
the external application program displaying a background check card link field;
the user pasting the background check card link into said field;
the external application program displaying a background check badge in the subject user's profile, the badge comprising a touch control which, when activated by a user viewing the subject user's profile, causes the subject user's background check card to be displayed.

19. A background check system comprising
a computing system, the computing system comprising a processor, a data storage, a user display of each of a plurality of users, and user input hardware of each of a plurality of users;
the user input hardware being adapted and configured to allow a human user to enter user input into the computing system;
the data storage including a computer-readable application program;
the processor being operatively connected to the data storage and adapted and configured to read and execute the application program from the data storage;
the processor being operatively connected to the user display and adapted and configured to display a graphical user interface of a user on that user's user display;
the application program comprising instructions for the processor to:
receive user input personal identification data of a subject user via the subject user's user input hardware, the personal identification data including sensitive personal information of the subject user;
receive input biometric data entered using the user input hardware;
authenticate the input biometric data as being that of the subject user;
transmit a background information request for the subject user to a background search provider database, the request including at least a portion of the personal identification data;
receive from the background search provider database background information about the subject user;
generate from the background information and write to the data storage a background check card, the background check card comprising a digital image comprising a visual representation of at least a portion of the subject user's background information in a human-readable format, the sensitive personal information of the subject user being excluded from the background check card;
display the background check card on the subject user's graphical user interface;
display a share control on the subject user's graphical user interface;
receive a user input via the subject user's user input hardware activating the share control;
when the share control is activated, display a prompt on the subject user's graphical user interface to input information identifying another user of the application program, transmit a message to the other user to be displayed on the other user's graphical user interface, indicating that the subject user has shared the subject user's background check card with the other user, receive input via the other user's user input hardware requesting to view the subject user's background check card, and in response to the input request from the other user, display the subject user's background check card on the other user's graphical user interface.
